(19) United States
(12) Patent Application Publication
(10) Pub. No.: US 2014/0214541 A1
(43) Pub. Date: Jul. 31, 2014

(54) METHOD AND SYSTEM FOR USER-CONTROLLED RENDERING OF MOBILE ADVERTISEMENTS

(71) Applicant: Kiosked Oy, Espoo (FI)

(72) Inventors: Antti Juhani Pasila, Helsinki (FI); Lars-Michaël Paqvalén, Espoo (FI)

(73) Assignee: Kiosked Oy, Espoo (FI)

(21) Appl. No.: 14/104,486

(22) Filed: Dec. 12, 2013

Related U.S. Application Data
(60) Provisional application No. 61/758,290, filed on Jan. 30, 2013.
(60) Provisional application No. 61/769,212, filed on Feb. 26, 2013.
(60) Provisional application No. 61/758,290, filed on Jan. 30, 2013.

(51) Int. Cl. G06Q 30/02

(52) U.S. Cl. CPC G06Q 30/0267; G06Q 30/0263
USPC 705/14.55; 705/14.6

(57) ABSTRACT

The aspects of the disclosed embodiment provide a method and system for user-controlled rendering of mobile advertisements and for context based targeting of content to users. The method includes collecting information associated with location of a user and content displayed on a user device. One or more relevant advertisements are identified based on the information which is collected from the user device. An option to view the one or more relevant advertisements is displayed on the user device. The relevant advertisement(s) are displayed on the user device when the user selects the option to view the advertisement. The method further includes identifying an element of a web page for targeting one or more content on the element. Additionally the method further includes identifying one or more characteristics of the element, wherein the one or more characteristics are identified for determining a context of the element. In addition, the method comprises targeting one or more content onto the element based on the context.

### CROSS-REFERENCE TO RELATED APPLICATIONS

This application claims priority to and the benefit of U.S. Provisional Application 61/758,290 filed 30 Jan. 2013, and U.S. Provisional Application 61/769,212 filed 26 Feb. 2013, the disclosures of which are incorporated herein by reference in their entireties.

### FIELD

The disclosed embodiment generally relates to user-controlled rendering of mobile advertisements and context based targeting of content.

### BACKGROUND

Typically, advertisements are targeted on mobile devices based on user profiles or demographics by mining interests and behavioral patterns of the users. Generally, these advertisements are displayed as on a new window or browser as and when users access content through their mobile device. Accordingly, a user is generally taken away from the content that the user is consuming and is forced to view the advertisements. In this situation, the user does not have any easy way to return to the content being consumed. This may lead to an unhappy customer experience. Further, the click rate monitored for such advertising may not be an accurate representation of user behavior. Other drawbacks of the traditional mobile advertising is that it is most often not contextually aware. In other words, the advertising lacks the awareness of what advertisements to show in what context, wherein advertisements are most often targeted to users blindly or based only on their demographics.

Therefore, there is a need for an improved method and system for targeting advertisements on mobile devices.

Typically, content such as, but not limited to, information, advertisement and commercial messages are targeted at online sources such as social networking sites, merchant sites and so forth. Most content providers target content using end-user information such as, but not limited to, location, behavior, and demographics. Alternately, content providers utilize keywords identified from the online source for targeting. For instance, a content provider may target content based on the kind of site or sub-section, for example, a women's magazine or a sports section etc. Most of the existing solutions can target content based on both user behavior and publication related keywords. However, bidding on keywords in order to attract traffic to the website is more popular.

Some of the current approaches use both user information as well as an analysis of keywords for targeting content. However, these approaches target content based on determining the most frequently occurring keywords in the website. A drawback of the current approaches is that the targeting of content is not based on an in-depth analysis of the content of the website. Instead, the current approaches are based on a partial analysis of the overall content of the website such as most frequently occurring keywords, or section headings of the website. This generally leads to targeting of content that is not particularly relevant to the user.

Accordingly, there is a need for an improved method and system for targeting of content.

### BRIEF DESCRIPTION OF THE FIGURES

The accompanying figures, where like reference numerals refer to identical or functionally similar elements throughout the separate views, and which together with the detailed description below are incorporated in and form part of the specification, serve to further illustrate various aspects of the disclosed embodiment and to explain various principles and advantages all in accordance with the disclosed embodiment.

FIG. 1 illustrates a block diagram of a system for user-controlled rendering of mobile advertisements in accordance with the disclosed embodiment.

FIG. 2 illustrates a flowchart of a method for user-controlled rendering of mobile advertisements in accordance with the disclosed embodiment.

FIG. 3 illustrates a flowchart related to analyzing content in a terminal in accordance with the disclosed embodiment.

FIG. 4 illustrates a block diagram of a system for targeting content in accordance with the disclosed embodiment.

FIG. 5 illustrates a flowchart of a method for targeting content in accordance with the disclosed embodiment.

FIG. 6 illustrates a flowchart of the method for targeting content in accordance with at least one aspect of the disclosed embodiment.

FIG. 7 illustrates a block diagram of a computing apparatus in accordance with the disclosed embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the disclosed embodiment.

### DETAILED DESCRIPTION

Before describing in detail the various aspects of the disclosed embodiment, it should be observed that the disclosed embodiment resides primarily in combinations of method elements and system components for user-controlled rendering of mobile advertisements and context based targeting of content. Accordingly, the method elements and system components have been represented where appropriate by conventional symbols in the drawings, showing only those specific details that are pertinent to understanding the aspects of the disclosed embodiment so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of objects does not include only those objects but may include other objects not expressly listed or inherent to such process, method, article, or apparatus. An object proceeded by “comprises . . . a” does not, without more constraints, preclude the existence of additional identical objects in the process, method, article, or apparatus that comprises the object.

Various aspects of the disclosed embodiment provide a method and system for user-controlled rendering of mobile advertisements. The method includes extracting information associated with current location of a user and content displayed on a user device. One or more relevant advertisements are identified based on the information which is extracted from the user device. Thereafter, an option to view the one or more relevant advertisements is displayed on the user device. The one or more relevant advertisements are subsequently displayed on the user device only if the user selects the option to view the advertisement. Further aspects of the disclosed embodiment provide a method and system for context based targeting of content. The method comprises identifying a content and context of an element such as a visual content of a web page. The method further comprises targeting content onto the element based on one or more of the identified content and context of the element.

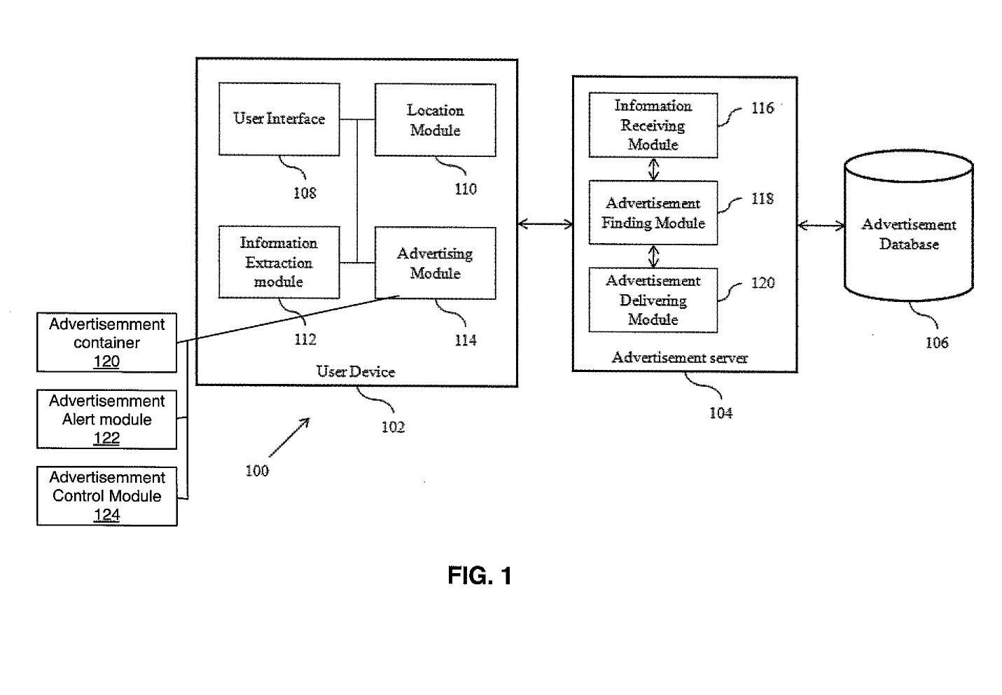

Referring to the figures and in particular FIG. 1, wherein a block diagram of a system 100 for user-controlled rendering of mobile advertisements is illustrated in accordance with at least one aspect of the disclosed embodiment. As illustrated, system 100 includes a user device 102, an advertisement server 104 and an advertisement database 106.

In at least one aspect, user device 102 is a mobile device such as, but not limited to, a mobile-phone, a smart-phone, a hand-held device, a personal digital assistant (PDA) and a tablet. In addition the device can be a laptop, personal computer (PC) or the like. In accordance with the embodiment, user device 102 includes a user interface 108, a location module 110, an information collection module 112 and an advertising module 114. User interface 108 allows a user to interact with user device 102. An example of user interface 108 can be the touch screen interface of a smart phone. Alternately, user interface 108 can be a display operationally connected with a keypad. In accordance with various aspects of the disclosed embodiment, user interface 108 is configured to receive input from the user. In addition, user interface 108 is configured to render one or more content such as, but not limited to, applications and advertisements to the user. Further, user interface 108 is configured to enable interaction between the user and the one or more content.

In accordance with at least one aspect of the disclosed embodiment, user device 102 further includes location module 110. In accordance with various aspects of the disclosed embodiment, location module 110 is configured to determine a current location of the user. In an embodiment, location module 110 configured in user device 102 to interact with a Global Positioning System (GPS) for determining the current location of the user. Additionally location module 110 can derive location using for example indoor location means, radio base stations or the like.

User device 102 also includes information collection module 112. In accordance with various aspects of the disclosed embodiment, information collection module 112 is configured to collect information associated with one or more content displayed on user device 102. The content items displayed on user device 102 may generally include any combination of visual, aural, or textual information and can be, but is not limited to, an advertisement, a commerce related information, text information, an audio, a video and a multimedia content. Information collection module 112 collects information related to the content, such as, but not limited to, metadata, keywords, and information related to images, audio files and video files associated with the content displayed on user device 102. For instance, if the content displayed on user device 102 is an image, then the metadata and keywords associated with the image can be collected by information collection module 112. Information collection module 112 is also configured to collect the current location of the user from location module 110. In an embodiment, a software code or HTML code or content within an application, is configured to indicate a place for a content container within the application/software code or HTML code. The content container is configured to identify appropriate content which can be utilized for finding one or more relevant advertisements. The content container can also be configured to identify the content in a code of the displayed content. In an embodiment, source for keywords are predefined to identify appropriate keywords which can be utilized for finding one or more relevant advertisements. The content container and the keywords source can be specified by an application developer. Thereafter, this information can be used to configure information collection module 112. In an embodiment, information collection module 112 also collects user history for determining the behavioral pattern of the user.

In accordance with various aspects of the disclosed embodiment, advertisement server 104 is configured to receive the information collected by information collection module 112. Advertisement server 104 is configured to utilize the information received from information collection module 112 to identify one or more relevant advertisements. In accordance with an embodiment, advertisement server 104 is configured to identify the one or more relevant advertisements from advertisement database 106. In an embodiment, advertisement server 104 utilizes the information collected by information collection module 112 to determine one or more of a location of the user and a context of the content. For example, information collection module 112 can send information that the user is in a particular part of a city and the content that is displayed is an image of a celebrity. Further, information collection module 112 can send keywords associated with the image such as, but not limited to, title and description of the image. The image related information can then be used to identify the appropriate context of the image. For example, based on the analysis, it can be determined that the image is related to an actor promoting a particular brand of sun glasses and accordingly relevant advertisements can be identified using this context. Thereafter, advertisement server 104 utilizes the determined location and context to identify the one or more relevant advertisements. In an embodiment, advertisement server 104 also utilizes information related to the behavioral pattern of the user for identifying the one or more relevant advertisements.

Advertisement database 106 includes a collection of advertisements which can be rendered on user device 102. The information received from information collection module 112 is matched with the advertisements stored in advertisement database 106 to identify the one or more relevant advertisements. For example, if the information received from information collection module 112 includes keywords such as trench-coat and California, the relevant match present in advertisement database 106 can be an advertisement which relates to trench-coats of a particular brand that has one or more retail outlets in California. Taking another example, if a user is reading about a location (such as reading an article about city in other country) on user device 102, then the location (related to the article) is compared with the current location of the user on a map to identify advertisements related to deals for trips to the location. The information associated with the current location of the user can also be used to identify advertisements specific to the location. The information associated with the current location of the user can include, but is not limited to, currency of the current location and languages used in the current location. For example, advertisements in Chinese language and advertisements with renminbi currency could be more relevant for a user located in China. In at least one aspect, the language used in user device 102 is detected to render an advertisement. The language can be detected for example by accessing language settings of a user device 102 used by the user or for example looking on the language settings of one or more applications used in the user device 102 Additionally language can be detected from cellular operator of the user. For example if cellular operator is China Mobile® then the users language is mostly likely Chinese. On the other hand if the cellular operator is Telenor® the language is most likely Norwegian. By detecting the language, users can be provided advertisements in the language they are familiar with. For example, a user familiar with Chinese can be provided with advertisements in Chinese even when the user is in another country such as France. In certain jurisdictions such as Switzerland, users may be familiar with German, French or both. Accordingly, by detecting the language used in user device 102, the user can be provided with advertisements in the language the user is familiar with.

In an embodiment, advertisement server 104 includes an information receiving module 116, an advertisement finding module 118 and an advertisement delivering module 120. Information receiving module 116 is configured to receive the information collected by information collection module 112. Advertisement finding module 118 is configured to identify the one or more relevant advertisements by matching the information received from information collection module 112 of user device 102 with advertisements stored in advertisement database 106. Advertisement delivering module 120 is configured to deliver the one or more relevant advertisements to user device 102. In an embodiment, advertisement delivering module 120 is configured to deliver the one or more relevant advertisements to an advertisement container 120 of a user device 102. The advertisement container is configured to retain the one or more relevant advertisements till the user selects an option to view the advertisement.

Advertising module 114 of user device 102 is configured to receive the one or more relevant advertisements. In an embodiment, advertising module 114 includes the advertising container 120 for holding the one or more relevant advertisements. Advertising module 114 is also configured to control display of the one or more relevant advertisements on user interface 108. In an embodiment, advertising module 114 includes an advertisement alert module 122 and an advertisement display control module 124. The advertisement alert module 122 is configured to display an alert on user interface 108 such that the alert includes an option to view the advertisements. For instance, when user device 102 receives the one or more relevant advertisements, the advertising alert module 122 can display the alert on user interface 108. The option which the user can select on user interface 108 to view the advertisement can be, but not limited to, an icon, a pop-up, an indicator and a button. The advertisement display control module 124 is configured to control the display of an advertisement on user interface 108. In one implementation, the advertisement display control module 124 controls the display such that the one or more relevant advertisements are displayed on user interface 108 only when the user selects the option to view the advertisements. Accordingly, once the alert is displayed on user interface 108 and the user selects the option to view the advertisements, the one or more relevant advertisements are displayed on user interface 108.

In accordance with various aspects of the disclosed embodiment, functionalities of one or more modules of user device 102 can be incorporated in user device 102 as a Software Development Kit (SDK) or a plug-in. For instance, the functionality of location module 110, information collection module 112 and advertising module 114 can be clubbed into a plug-in that can be installed on user device 102 for user-controlled rendering of mobile advertisements. Similarly, the functionality of information receiving module 116, advertisement finding module 118 and advertisement delivering module 120 of advertisement server 104 can be incorporated into software that can be installed on advertisement server 104 for providing user-controlled rendering of mobile advertisements.

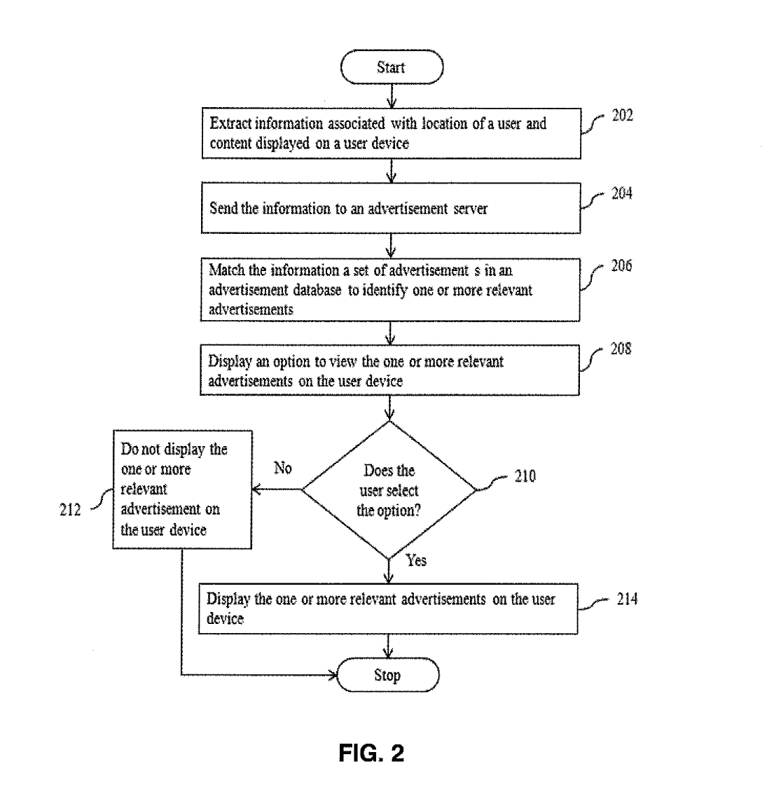

Turning now to FIG. 2, which illustrates a flowchart of a method for user-controlled rendering of mobile advertisements in accordance with at least one aspect of the disclosed embodiment.

At block 202, information associated with current location of a user and content displayed on a user device such as user device 102 is collected. In an embodiment, the current location of the user is determined using GPS of the user device by the location module 110. The content displayed on the user device may include one or more of, but not limited to, an advertisement, a commerce related information, text information, an audio, a video and a multimedia content. The information collected can include, but is not limited to, metadata, keywords, and information related to images, audio files and video files associated with the content displayed on the user device. For instance, if the content displayed on the user device is an image, then the metadata of the image is collected.

At block 204, the information collected from the user device is sent to an advertisement server such as advertisement server 104.

At block 206, the information received at the advertisement server is matched with a collection of advertisements stored in an advertisement database to identify one or more relevant advertisements. For example, the information received from the user device can be matched with the metadata of the advertisements stored in the advertisement database to identify the one or more relevant advertisements. In an embodiment, the information received from the user device includes details related to the content and the user. This information can be utilized while identifying the one or more relevant advertisements. Thus, context sensitive advertisements for content displayed on the user device are rendered to the user.

Thereafter, at block 208, an option to view the one or more relevant advertisements is displayed on the user device. The user can select the option to view the one or more relevant advertisements. The option displayed on the user device, which the user can select to view the one or more relevant advertisements can be, but not limited to, an icon, a pop-up, an indicator and a button.

Subsequently, at block 210, it is determined whether the user selects the option for viewing the one or more relevant advertisements. If the user does not select the option to view the one or more relevant advertisements, then the method proceeds to block 212, wherein the one or more relevant advertisements are not displayed on the user device. If the user selects the option to view the one or more relevant advertisements, then the method proceeds to block 214, wherein the one or more relevant advertisements are displayed on the user device. For example, if the user clicks on an icon notifying an option to view a relevant advertisement on the user device, the relevant advertisement is displayed on the user device.

In an exemplary embodiment, an application developer installs a SDK. The application developer configures a code to indicate content containers. The content containers are used to identify appropriate content which can be utilized for finding one or more relevant advertisements. Further, the application developer can specify source from where the appropriate and additional keywords can be collected such that the keywords can be utilized for finding one or more relevant advertisements. As an example a user A posts an image on an application developed by the application developer and adds description to post. The developer has defined that posting area of the application includes a content container. The SDK thus recognizes the image and the description posted by User A. The description is analyzed and relevant keywords are identified in the description or the description is used as keywords. The source of the image is identified to be from a website of make-up products of brand A and brand B. When User B views the post of User A on a mobile device, information associated with the current location of User B and keywords associated with the post is collected. The information is utilized to match with a collection of advertisement in the advertisement database. In this case, advertisements related make-up products with retail-outlets in proximity of User B′s location are identified as relevant. Once the relevant advertisements are identified, an icon is displayed on a user interface of the mobile device. When the user clicks on the icon, the advertisement related to make-up products with retail-outlets in proximity of User B's location are displayed on the mobile device of User B.

In an exemplary embodiment, the method and system for user-controlled rendering of mobile advertisements is provided as a service to one or more application developers. For example, the service can be provided to game developers, video distributors etc. In accordance with the embodiment, the service provider provides the SDK to the application developers. This enables the application developers to utilize the functionality provided by the service provider by installing the SDK on their applications. Various possible configuration changes can be made as desired. For example, certain application developers may be interested in rendering advertisements that are specific to a particular application. For example, for a game, an application developer may be interested in rendering advertisements that are related to products associated with the game such as t-shirts, caps, posters, game demos and so forth. Alternately, the application developer may want to display advertisements that are related to the franchise of the application developer. Other variations would be readily apparent to those ordinarily skilled in the art.

The disclosed method and system renders user-controlled advertisements based on location of the user and information associated with the content displayed on the user device. Since the advertisements are context and location sensitive, relevant advertisements are rendered on the user device. Thus, relevant advertisements enhance the chances to increase revenue for advertisers. Further, the advertisements are displayed on the user device only when the user wishes to view the advertisements. Thus, the users are not taken away from content the users are currently consuming on the user device unless the users choose to do so. Accordingly, by providing the abovementioned advantages, the disclosed method and system makes user experience on-demand, contextual and location sensitive rendering of advertisements.

Example of a code with a content container indicator within an application is shown below.

#include <stdio.h>
int main( )
{
start_content_contaier area (with parameters A; B, C) {
char string[ ] = ″Hello World″;
show_banner = ”related to conten”;
end_content container_area }
printf(″%s\n″, string);
return 0;

In the example code the SDK would be configured to find “start content container area” indicator and “end content container area” indicator. The content within the area would be used as keywords or other source to identify appropriate advertisement or other content items related to the application. SDK can utilize parameters (A, B, C) set by the developer to limit/define rules of associating content for the software or for example for the banner.

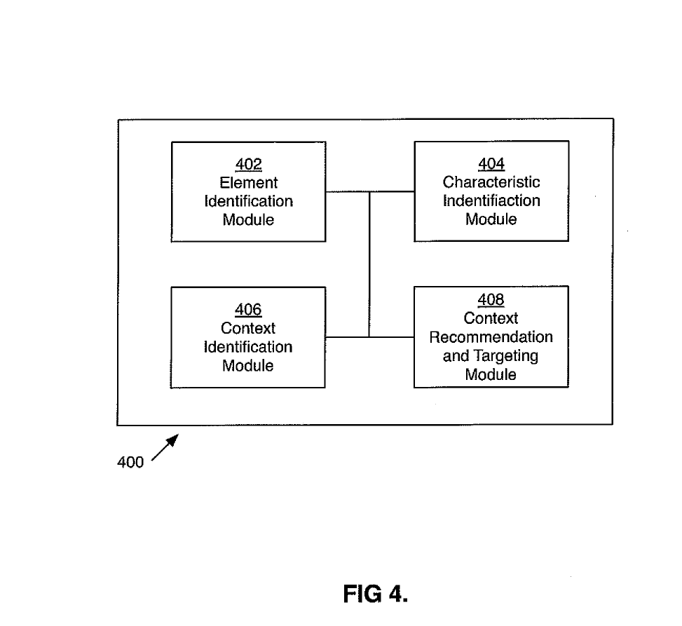

FIG. 4 illustrates a block diagram of a system 400 for targeting content in accordance with at least one aspect of the disclosed embodiment. Application used by user in the example can be web browser used to render web content for the user. As illustrated, system 400 includes an element identification module 402, a characteristic identification module 404, a context identification module 406 and a content recommendation and targeting module 408.

In an embodiment, element identification module 402 is configured to identify an element such as, but not limited to, an image, an audio, and a video on a web page. For example, element identification module 402 can be configured to identify images present on the web page of a clothes merchant. In an embodiment, element identification module 402 is configured to identify the element based on one or more criteria. For example, a publisher, merchant or vendor may be interested in identifying images that are of a particular size. Alternately, the publisher may be interested in identifying videos that have a particular run time. Elements can be any content including advertisements.

In an embodiment, characteristic identification module 404 is configured to identify one or more characteristics of the element. The one or more characteristics of the element can be element name, element information, element creator, element owner, and element meta-data. For example, an image can have characteristics such as image name, image type, image rights owner, when was the image taken, where was the image taken, who took the image and so forth. In an embodiment, the one or more characteristics of the element comprise one or more of, but not limited to, an element right holder, one or more keywords associated with the element, and meta-data of the element.

In an embodiment, characteristics identification module 404 is configured to identify the one or more characteristics by analyzing information associated with the web page. For example, the meta-data of the web page can be analyzed to determine the element name and text or other characteristics associated with the element. In another embodiment, characteristics identification module 404 is configured to query a third party information provider to obtain the one or more characteristics of the element. For example, an image information provider may be queried with an image name such as “Abc.jpg” to obtain the characteristics of the image. The one or more characteristics of the element can be used to identify a context associated with the element.

In an embodiment, context identification module 406 is configured to identify the context of the element. For example, in an image, the context can be identified based on who is part of the image, what is the situation, what is the location and date when the image was taken and so on and so forth. Taking an instance where in an image, a tennis player P1 is advertising a particular sports shoe brand B1, then the context can be P1 advertising shoes of brand B1 at location L1 on a particular date. The contextual information can then be used to identify appropriate content for targeting.

In an embodiment, content recommendation and targeting module 408 is configured to identify one or more content for targeting. In addition, content recommendation and targeting module 408 is configured to identify the one or more content based on at least one of the one or more characteristics and the context of the element. For example, content recommendation and targeting module 408 can identify advertisements for targeting based on the context. In addition, content recommendation and targeting module 408 is configured to target at least one of the one or more content on to the element. For example, content recommendation and targeting module 408 can target an advertisement on to an image provided on the web page.

In accordance with various aspects of the disclosed embodiment, system 400 can be implemented as a script such as for example an Application Programming Interface (API) or a JavaScript™ code snippet that can be embedded into a web page.

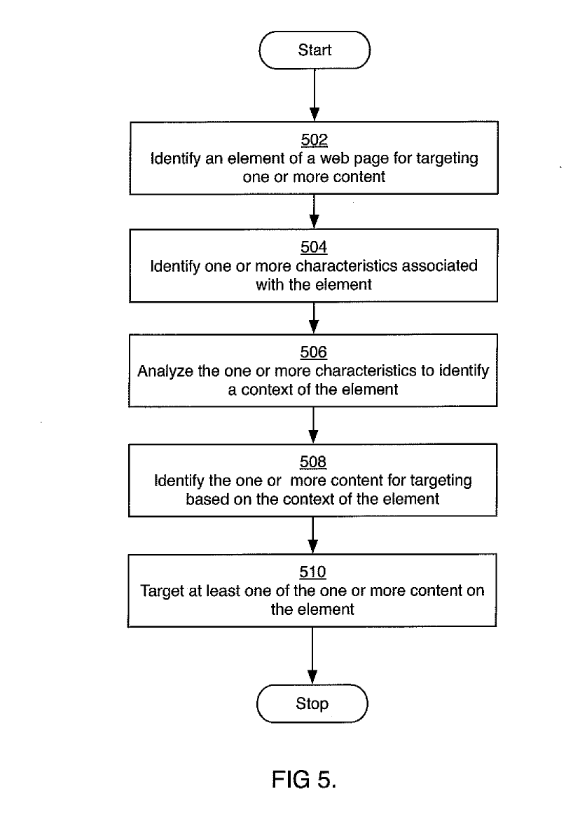

FIG. 5 illustrates a flowchart of a method for targeting content in accordance with at least one aspect of the disclosed embodiment. Each of the one or more content can be one of, but not limited to, an advertisement, a commerce related information, text information, an audio, a video and a multimedia content.

At block 502, one or more elements of a web page for targeting one or more content are identified. Each element can be one of, but not limited to, a visual element, a text element, an audio element and an audio-visual element. For instance, the element can be one of an image, an audio and a video rendered on the web page. The one or more elements are identified for the targeting at least one of the one or more content on at least one element of the one or more elements. For example, an image can be identified for targeting an advertisement of a product over the image.

In an embodiment, the one or more elements are identified using an element recognition script embedded into the web page. For example, a publisher can add a JavaScript™ code snippet to his/her HTML page for recognizing the images on his/her page on to which content can be targeted. In addition, the images may be identified based on specific size limitations.

At block 504, one or more characteristics associated with an element of the one or more elements are identified. The one or more characteristics associated with the element can be, but are not limited to, element name, element date of creation, element meta-data, element rights owner and element information. For instance, for an image on a web page where a celebrity is advertising a product, the characteristics associated with the image can be the image name, the image rights owner, the text describing the image, the meta-data of the image, the occasion or event where the image was taken and so forth.

In an embodiment, the one or more characteristics of the element are identified using the information associated with the web page. For example, the one or more characteristics of the element may be identified by analyzing one or more of the content, the meta-data of the web page and by analyzing the text associated with the element. The analysis can be performed using techniques such as, but not limited to, Natural Language Processing (NLP) for extracting one or more keywords associated with the element. Additionally keywords for the element (content item) can be derived from other keyword source such as a 3^{rd} party web service.

In another embodiment, the one or more characteristics and keywords of the element/content items are retrieved from a rights holder of the element/the content item. In an instance, the retrieval can be accomplished using the API. The API first identifies the right holder of the element. The identification may be accomplished by contacting a third party information provider. For example, an image data can be obtained by contacting a firm such as Getty Images™, Inc. The API retrieves a URL (Uniform Resource Locator) of the element and sends it to the third party for obtaining the one or more characteristics. The third party uses the URL to identify the element in the index and the right holder of the element. The third party then sends the identity of the right holder and a unique ID (identification) for the element. The unique ID is used by the right holder for identifying the element. Thereafter, the one or more characteristics are retrieved from the right holder. The retrieval can be accomplished by sending the unique ID of the element to the right holder and requesting the right holder to provide the one or more characteristics of the element. The targeting of the one or more content is based on determining a context from the one or more identified characteristics.

At block 506, the one or more characteristics are analyzed to identify the context associated with the element. The targeting of the one or more elements is based on the context. For instance, the one or more characteristics identified may be processed using techniques such as NLP to identify the context. Subsequent to block 506, an option may be provided to the publisher to manually select the one or more content to be targeted based on the context.

Alternately, the method proceeds to block 508, wherein one or more content are identified automatically, based on the context.

In an embodiment, the one or more content are identified using keyword matching. In an embodiment, the one or more content are stored in a database. The one or content can be extracted from the database using techniques such as, but not limited to, keyword and meta-data matching.

Subsequent to the identification, each of the one or more content can be scored. The score may be calculated based on a match percentage. Thereafter, the one or more content can be sorted based on the score and top ‘n’ content of the one or more content may be selected for targeting. For example, top 3 advertisements may be selected for targeting onto an image on a web page. In addition, data regarding each of the top ‘n’ content is linked with the element. For instance, data regarding the top 3 advertisements is linked with the image. Considering a scenario where an advertisement of a product is to be targeted onto an image, then the link to the product purchase can be associated with the advertisements and the image. Accordingly, when such an advertisement is targeted on the image and when a user clicks the advertisement, the user gets redirected to the web page for purchase of that product.

At block 510, at least one of the one or more content is targeted on the element. For instance, the content may be overlaid on an area of the element. In an example, one or more advertisements identified for an image on a web page are overlaid in a series of cascading thumbnails on a top corner of the image. In an embodiment, the at least one content is selected based on one or more criteria. The one or more criteria can be based on one or more of, but not limited to, user attributes, merchant attributes, and content information. For instance, the at least one content is selected based on attributes of the user such as, but not limited to, location, cookies or other id, local time and other available behavioral data.

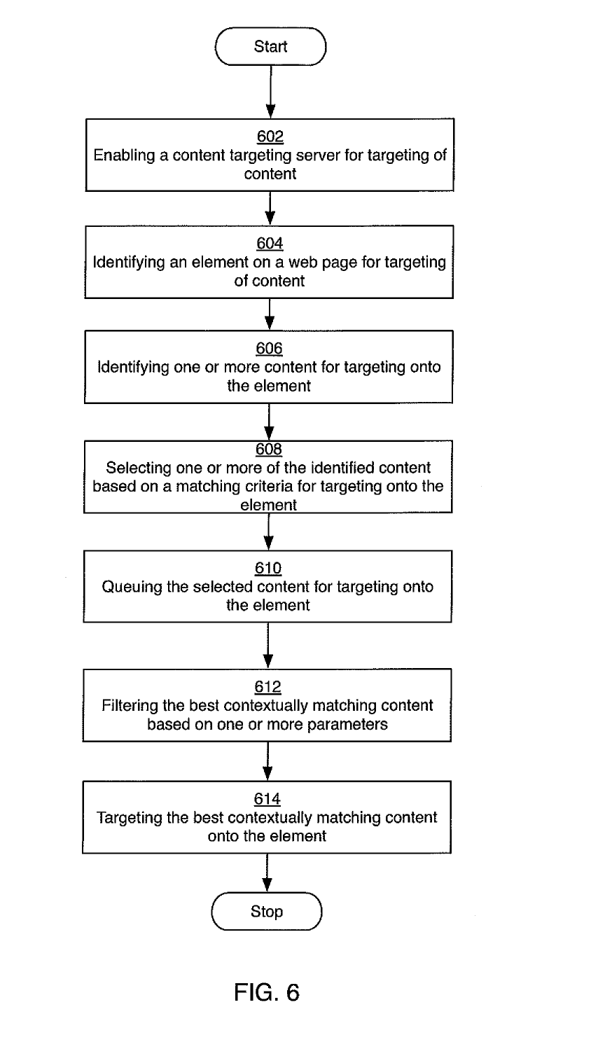

FIG. 6 illustrates a flowchart of the method for targeting content in accordance with at least one aspect of the disclosed embodiment. Optionally, the method may be implemented as a content targeting service for targeting content on an element of a web page.

At block 602, a publisher of digital content enables for the content targeting service. For example, the publisher adds a JavaScript™ code snippet for targeting content to his/her web page.

At block 604, an element such as, but not limited to, an image on the web page is identified. In addition, one or more of a content and context of the element are identified.

Subsequently, at block 606, one or more content for targeting such as, but not limited to, advertisements and commerce messages are identified. The identification can be performed either manually or automatically. In case, the identification is performed manually, the publisher identifies the one or more content for targeting. In the other case, firstly the rights owner of the element is identified. This can be performed by comparing the content such as an image with a fingerprint index of the right owners of different images. This can be performed by matching the content such as image to a fingerprint index to recognize the rights holder and a unique ID of the content. For instance, the image name can be compared with the fingerprint index to identify the name and details of the rights holder for the image. Thereafter, information regarding meta-data and keywords matching the unique ID is retrieved from the rights owner, which is subsequently used to identify the one or more content such as products or advertisements for targeting. In this, the content's keywords and meta-data are matched with different content such as products or advertisements of a content database to determine which of the contents are the best match for the content's keywords and meta-data. For instance, products or advertisements can be selected from a products/advertisements database based on keywords and meta-data matching.

Once the content for targeting has been identified either manually or automatically, at least one of the one or more content is selected for targeting on the element at block 608. For instance, the best matches of products and advertisements are selected for the element. Alternately, the one or more content may be scored based on the percentage of matching and the one or more content with the highest scores are selected.

Thereafter, at block 610, the content selected for targeting are put in queue for targeting. Further, the content can be queued based on the match percentage. In addition, data regarding the selected content can be linked with the element.

After linking the content selected for targeting with the element, one or more of the content is filtered for targeting at block 612. The content filtering can be performed to identify the best contextually matching content. For example, the content filtering can be performed based on different parameters such as, but not limited to, what kind of information/attributes are be shown to a specific consumer, what language information is to be displayed (browser language), what is the currency to be shown (location), what store to link the consumer (location), which product variant/product image to show (cookie and identity), which merchant—best converting, lowest price, nearest, most preferred based on cookie or other identifying information. The information regarding the customer can be collected when the consumer visits the web page wherein the content targeting service is already implemented. Accordingly, when the consumer visits such a web page, the service checks available data from consumer, location, cookie or other identifier, local time and other available behavioral data.

Subsequently, at block 614, the best contextually matching content are shown to the consumer. In this, the information is tailored based on the attributes and information gathered from that specific user, their location, time, preference and estimation of interest to ensure highest relevancy.

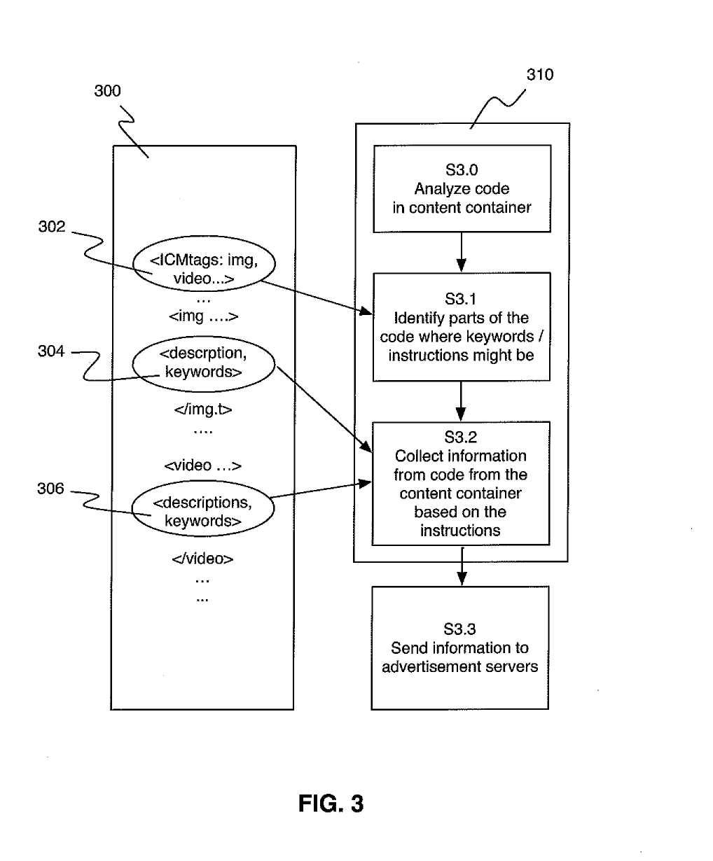

As an additional example of at least one aspect of the disclosed embodiment of present the disclosure is shown in FIG. 3. A code 300 such as Hyper Text Mark Up (HTML) code (or other code that can be used as source code for rendering content for a user) contains content container indicator 302. The code 300 can be stored in a memory of a terminal such as buffer memory, database arrangement, file system etc. The code 300 can be originated from web browsing session or it can be stored there during the web browsing session or it can be for example web browser memory/cache/buffer i.e. it can be the code that is used to render web pages by the browser. Information collection module 310 is configured in block S3.0 to start to analyze content in the code 300 to find content containers/content container indicators 302, 304, 306 or alike. In block S3.1 the information collection module 310 search for information that identifies where in the code stored in the content containers might include keywords or other descriptions. As an example content container information data code 302: <ICMtag: img, video> would define that HTML tags <img> and <video> could have relevant information which can be used to determine appropriate advertisements for the content related to information in the code 300. In block S3.2 the information collection module 310 search for information from places in the code indicated in block S3.1 i.e. tags of <img> and <video>. In example description and keywords related to image tag <img> and keywords and descriptions related to video tag <video> would be found. In block S3.2 the information collection module 310 would collect image related information 304 and video image related information 306. Said information would be sent to advertisement server system in block S3.3. Example code and information within <img> tag:

<img src=“Building.gif” alt=“Helsinki Finland”>

i.e. there is a gif figure named Helsinki having alternative name “Helsinki Finland”. Said information “Building, Helsinki and Finland” would be used as keywords to be sent to advertisement server.

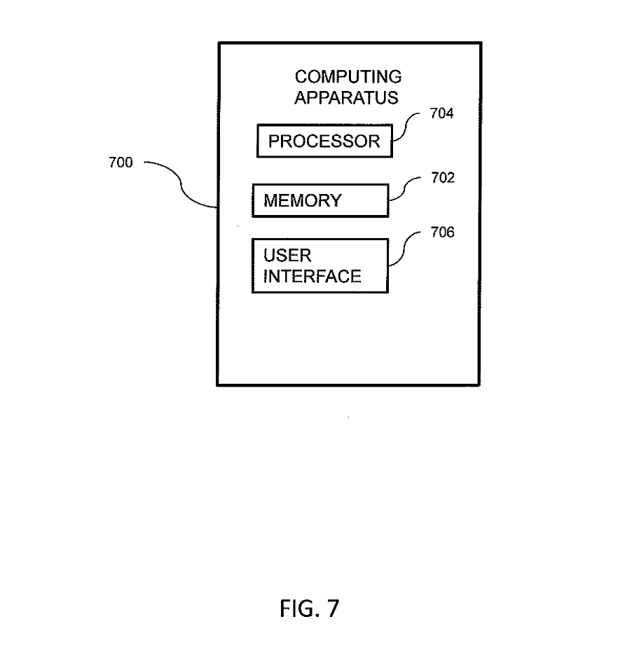

In at least one aspect of the disclosed embodiment, the systems and methods disclosed herein may be executed by one or more computers under the control of one or more programs stored on computer readable medium. FIG. 7 shows a block diagram of a computing apparatus 700 that may be used to practice aspects of the disclosed embodiment. In at least one exemplary aspect, each of the user device 102, advertisement server, content targeting system 400, and other disclosed devices and systems may be implemented using an instance or replica of the computing apparatus 700 or may be combined or distributed among any number of instances or replicas of computing apparatus 700.

The computing apparatus 700 may include computer readable program code stored on at least one computer readable medium 702 for carrying out and executing the processes and methods described herein. The computer readable medium 702 may be a memory of the computing apparatus 700. In alternate aspects, the computer readable program code may be stored in a memory external to, or remote from, the apparatus 700. The memory may include magnetic media, semiconductor media, optical media, or any media which is readable and executable by a computer. Computing apparatus 700 may also include a processor 704 for executing the computer readable program code stored on the at least one computer readable medium 702. In at least one aspect, computing apparatus may include one or more input or output devices, generally referred to as a user interface 706, similar to the user interface described above, which may operate to allow input to the computing apparatus 700 or to provide output from the computing apparatus 700, respectively. The user interface can include device display, touch screen, buttons, audio input and output.

Therefore, the disclosed method and system enables context based targeting of content. In addition, the method and system enables targeting based on information associated with the user. Therefore, the content being targeted is likely to be of relevance to the user. The method and system also enables the targeting of content such as advertisements to be based on information about the merchant. This is advantageous in a scenario wherein the method and system enables the targeting of advertisements for only those products that are in stock. Therefore, the user is not misled into navigating to a web page only to find that the product being advertised is no longer in stock.

Those skilled in the art will realize that the above-recognized advantages and other advantages described herein are merely exemplary and are not meant to be a complete rendering of all of the advantages of the various aspects of the disclosed embodiment.

In the foregoing specification, specific aspects of the disclosed embodiment have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the disclosed embodiment. The benefits, advantages, solutions to problems, and any element(s) that may cause any benefit, advantage, or solution to occur or become more pronounced are not to be construed as a critical, or required

1. An apparatus for rendering advertisements comprising:
a processor; and
a memory comprising program code, wherein the processor under control of the program code causes the apparatus to:
render one or more content items on a device display;
provide a content container in the program code for identifying at least one of the one or more content items for use in advertisement selection;
collect information related to the at least one identified content item and location information associated with the device; and
provide the collected information to a system configured to identify advertising for rendering on the device display.

2. The apparatus of claim 1, wherein the content container includes an identification of a keyword source for the information related to the at least one identified content item.

3. The apparatus of claim 1, further comprising an information collection module configured by the identification in the content container to collect the information related to the at least one identified content item and the location information associated with the device.

4. The apparatus of claim 3, wherein the information collection module is configured to collect user behavior patterns as part of the information related to the at least one identified content item and location information associated with the device.

5. The apparatus of claim 1, further comprising an advertising module configured to receive and display the identified advertising.

6. The apparatus of claim 5, wherein the advertising module is further configured to generate an alert upon receiving the identified advertising and display the identified advertising only upon selection of an option to display the advertising.

7. A method for rendering advertisements comprising:
rendering one or more content items on a device display;
identifying at least one of the one or more content items for use in advertisement selection;
collecting information related to the at least one identified content item and location information associated with the device; and
providing the collected information to a system configured to identify advertising for rendering on the device display.

8. The method of claim 7, further comprising collecting user behavior patterns as part of the information related to the at least one identified content item and location information associated with the device.

9. The method of claim 7, further comprising receiving the identified advertising from the system configured to identify advertising and rendering the identified advertising on the device display.

10. The method of claim 9, further comprising generating an alert upon receiving the identified advertising and displaying the identified advertising only upon selection of an option to display the advertising.

11. An apparatus for targeting displayed content comprising:
a processor; and
a memory comprising program code, wherein the processor under control of the program code, causes the apparatus to:
identify an element for targeting content;
obtain characteristics of the element to determine a context of the element; and
select content for targeting onto the element from the determined context.

12. The apparatus of claim 11, further comprising an element recognition script, embedded in a web page on which the element is displayed, for identifying the element for targeting content.

13. The apparatus of claim 11, further comprising a characteristics identification module configured to obtain the characteristics of the element from information associated with a web page on which the element is displayed.

14. The apparatus of claim 11, further comprising a characteristics identification module configured to obtain the characteristics of the element from an information provider service.

15. The apparatus of claim 11, further comprising a content recommendation and targeting module configured to select the content for targeting onto the element from the characteristics and context of the element.

16. A method for targeting displayed content comprising:
identifying an element for targeting content;
obtaining characteristics of the element to determine a context of the element; and
selecting content for targeting onto the element from the determined context.

17. The method of claim 16, further comprising using an element recognition script, embedded in a web page on which the element is displayed, for identifying the element for targeting content.

18. The method of claim 16, further comprising obtaining the characteristics of the element from information associated with a web page on which the element is displayed.

19. The method of claim 16, further comprising obtaining the characteristics of the element from an information provider service.

20. The method of claim 16, further comprising selecting the content for targeting onto the element from the characteristics and context of the element.
